(19) United States
(12) Patent Application Publication
(10) Pub. No.: US 2026/0307824 A1
(43) Pub. Date: Oct. 8, 2026

(54) LUNAR LANDER DESCENT CONTROL

(71) Applicant: Raytheon Company, Arlington, VA (US)

(72) Inventors: John B. Schlaerth, Redondo Beach, CA (US); Marcus A. Teter, Belgrade, TN (US); Nathaniel Essington, Los Alamitos, CA (US); Kristen Butler, Los Angeles, CA (US); Douglas B. Tyler, Torrance, CA (US)

(21) Appl. No.: 19/320,534

(22) Filed: Sep. 5, 2025

Related U.S. Application Data
(60) Provisional application No. 63/691,727, filed on Sep. 6, 2024.

(51) Int. Cl. B64G 1/24; B64G 1/10; B64G 1/36; B64G 1/62

(52) U.S. Cl. CPC B64G 1/244; B64G 1/1071; B64G 1/36; B64G 1/625

(57) ABSTRACT

An apparatus and system for lunar landing are disclosed that use an image-based analysis to enhance descent control and surface proximity estimation. Cameras oriented toward the lunar surface capture sequential images during terminal descent. By analyzing the rate of change in brightness histograms derived from the images, dust-induced obscuration of the surface is detected and contrast loss in surface features quantified. The histogram-based approach enables real-time determination of the altitude and attitude of the lander, even when radar or other sensor techniques become unreliable due to dust. Pre-calibrated models or lookup tables are used to correlate histogram changes with altitude, generating control signals to adjust descent rate and attitude for the landing. The system operates as a primary or redundant proximity sensor.

### PRIORITY CLAIM

This application claims the benefit of priority to U.S. Provisional Patent Application Ser. No. 63/691,727, filed Sep. 6, 2024, which is incorporated herein by reference in its entirety.

### FIELD

The subject matter disclosed herein relates to vehicular control based on external imaging, and more particularly, landing control based on dust imaging for a lunar lander.

### BACKGROUND

A successful soft landing on the moon is a difficult maneuver to realize for any vehicle attempting to do so. Several high-profile recent attempts by different countries and private corporations have ended with unsatisfactory results, mostly due to inaccurate altitude and/or attitude determination above the lunar surface (either too high or too low, and/or wrong contact angle) during their terminal descent. In this final descent phase to the moon, the motor exhaust plume from a vehicle attempting a soft landing on the lunar surface will kick up fine lunar dust particles and obscure the ground at an increasing rate as altitude decreases, rendering the laser rangefinders and radar means typically used for altitude measurement ineffective in the most critical phase for such altitude determination. This lack of information in the very final step of a lunar touchdown therefore presents a risk in lunar landings.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 illustrates a block diagram of a lunar lander system, according to some embodiments.

FIG. 2 illustrates an example of histogram stretching based on lunar landing, according to some embodiments.

FIG. 3 illustrates a method of histogram stretching for lunar landing, according to some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

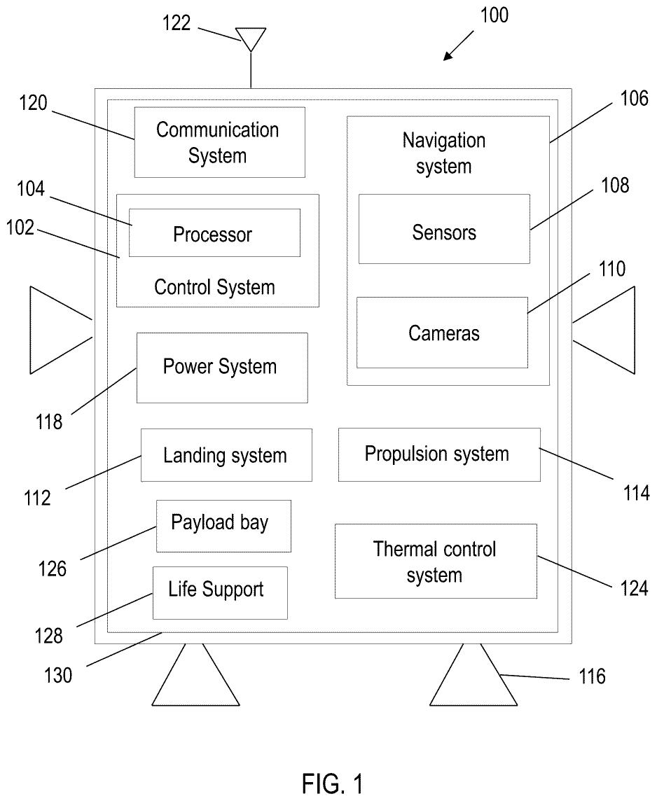

A lunar lander is a complex spacecraft that has a large number of complicated and interconnected systems and elements designed to safely transport payloads or crew to the Moon's surface. Systems in the lander may include a propulsion system, a navigation system, a control system, a power system, a communication system, a thermal control system, a landing system, payload and science instruments, a life support system, a structural system, a dust mitigation system, and, for at least crewed missions, an abort system. Only the systems relevant to the landing are shown in FIG. 1, which illustrates a block diagram of a lunar lander system, according to some embodiments. Other elements may be present, but are not described for convenience.

As shown in FIG. 1, the lunar lander 100 includes several systems and elements that are used to control the landing. The placement and number of systems shown in FIG. 1 are only examples and may be adjusted as desired for a particular lunar lander 100 and/or mission. The control system 102 contains one or more processors 104 and memory, which is responsible for overall command and data handling as well as including other electronic systems to implement the landing method herein. The processor 104 interfaces with subsystems that include throttle and attitude control of the lunar lander 100. The software operating on the processor 104 implements control algorithms, including the image processing routines for histogram analysis and proximity determination. The control system 102 thus processes navigation data and manages all spacecraft systems. The control system 102 includes guidance algorithms that calculate and adjust descent trajectory, attitude control software that maintains proper orientation during descent, and an engine control unit for managing engine throttle and gimbal.

The throttle subsystem controls the propulsion system 114 and effectively the thrusters 116. The propulsion system 114 is the primary descent engine and associated thrusters used to control the descent rate and attitude of the lunar lander 100. The propulsion system 114 receives control signals from the processor 104 to modulate thrust provided by the thrusters 116 during landing. The thrusters 116 include main descent engines used for primary thrust and for deceleration and controlled descent, along with a Reaction Control System (RCS) that include small thrusters for precise attitude control and minor trajectory adjustments. Fuel tanks and feed systems store and deliver propellants to the thrusters 116. The number and placement of the thrusters 116 shown is merely an example. The rate of descent and altitude are input parameters to any lunar landing descent profile. Each landing vehicle has design constraints for the contact velocity and angular attitude relative to the lunar surface. Based on the speed and distance to the lunar surface, the lander can make the appropriate throttle and attitude adjustments to stay within the design envelope for landing contact, based upon the altitude telemetry readings provided.

The navigation system 106 processes data from sensors 108 and one or more cameras 110 to determine the position, velocity, and orientation of the lunar lander 100 relative to the lunar surface and guide the lunar lander 100 accordingly. The cameras 110 are positioned to capture images of the lunar surface and the dust plume generated by the exhaust generated by the thrusters 116. The cameras 110 provide real-time image data to the navigation system 106 and processor 104 for analysis. Similarly, the sensors 108 include inertial measurement units (IMUs), star trackers, radar altimeters, and laser rangefinders, among others. The sensors 108 provide navigation and attitude data to the navigation system 106 and processor 104 for analysis. The IMU measures acceleration and rotation rates, the star trackers determine spacecraft orientation by observing star positions, the radar altimeter measures distance to the lunar surface, the laser rangefinders provide precise altitude measurements, and the optical cameras are used for visual navigation and proximity sensing. A GPS receiver may be used for navigation in Earth orbit before lunar transfer.

The landing system 112 includes hardware such as landing legs and touchdown sensors. The landing system 112 detects surface contact and help stabilize the lunar lander 100 upon touchdown. The landing system includes landing legs and sensors to detect surface contact. The landing legs absorb impact and stabilize the lander on uneven terrain. The touchdown sensors detect contact with the lunar surface.

A power system 118 may include solar panels and batteries. The solar cells generate electricity from sunlight and the batteries store electrical energy for use during lunar night or when solar panels are not effective. The power system 118 may also include a power distribution unit to manage power allocation to various systems.

Communication with Earth may be facilitated through a communication system 120 that includes high-gain and low-gain antennas 122, along with transponders and radio equipment. The high-gain antennas are used for long-distance communication with Earth; the low-gain antennas are used for omnidirectional communication. The transponders and radio equipment are used for sending and receiving signals, including processor commands and communications from external equipment such as from Earth and from other spacecraft.

To maintain optimal operating conditions, the lunar lander 100 may employ a thermal control system 124 with radiators, heaters, and thermal insulation. The radiators in the thermal control system 124 dissipate excess heat developed during entry into a planetary atmosphere or exposure to a heat source. The heaters in the thermal control system 124 maintain equipment within operational temperature ranges while in space or in other environments. The thermal insulation in the thermal control system 124 protects against extreme temperature variations (such as during re-entry into the Earth atmosphere).

Many landers also carry scientific payloads and instruments for lunar exploration. Such equipment in the lunar lander 100 may be stored in a payload bay 126 or compartment for storing equipment or samples. For crewed missions, a life support system 128 provides oxygen and CO₂ scrubbers, temperature and humidity control, and water recycling.

The structure of the lunar lander 100 includes primary and secondary components that support and house various systems. Given the challenges posed by lunar dust, a dust mitigation system 130 may be incorporated. The dust mitigation system 130 may include protective covers and specialized coatings to reduce dust adhesion.

For crewed missions, an abort system may be included for emergency escapes during descent. The abort system may provide emergency propulsion for rapid escape in case of critical failure during descent.

The processor 104 may include a hardware processor (or equivalently processing circuitry) (e.g., a central processing unit (CPU), a GPU, a hardware processor core, or any combination thereof). Various memories, such as main memory and a static memory may communicate with each other and the via a bus. The main memory may contain any or all of removable storage and non-removable storage, volatile memory or non-volatile memory.

The lunar lander 100 may further include a display unit such as a video display, an alphanumeric input device (e.g., a keyboard), and a user interface (UI) navigation device (e.g., a mouse). In an example, the display unit, input device and UI navigation device may be a touch screen display. The lunar lander 100 may additionally include a storage device (e.g., drive unit), a signal generation device (e.g., a speaker), a network interface device, and one or more sensors, such as a global positioning system (GPS) sensor, compass, accelerometer, or another sensor. The lunar lander 100 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device may include a non-transitory machine readable medium (hereinafter simply referred to as machine readable medium) on which is stored one or more sets of data structures or instructions (e.g., software) embodying or utilized by any one or more of the techniques or functions described herein. The non-transitory machine readable medium is a tangible medium. The instructions may also reside, completely or at least partially, within the main memory, within static memory, and/or within the hardware processor during execution thereof by the electronic device. The machine readable medium may include a single medium or multiple media (e.g., a centralized or distributed database, and/or associated caches and servers) configured to store the one or more instructions.

The term “machine readable medium” may include any medium that is capable of storing, encoding, or carrying instructions for execution by the electronic device and that cause the lunar lander 100 to perform any one or more of the techniques herein, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions may further be transmitted or received over a communications network using a transmission medium via the network interface device utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), IEEE 802.11 family of standards, and wireless data networks. In an example, the network interface device may include one or more physical jacks (e.g., Ethernet, coaxial, or phone jacks) or one or more antennas to connect to the transmission medium.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

As above, one of the most precarious portions of a lunar mission is the lander landing on the surface of the underlying structure. Particularly on atmospheres such as the moon, the thrusters kick up dust particles and obscure the ground, potentially rendering sensor and visual data ineffective. A closed-loop solution is presented to engage the throttle from descent and attitude control engines as the lunar lander approaches the surface of the moon. Control is at least partially based on a discernable low contrast flat field light signature from an onboard camera pointing in the aft descent direction toward the moon. The low contrast begins to manifest itself (from previous landing data) to varying degrees depending on the lunar regolith composition at the landing site. The low contrast begins to manifest itself at a maximum altitude of about 300 feet above the surface and a minimum altitude of about 40 feet above the surface.

As landings are normally scheduled to occur on the sunlit side of the moon, particularly at the poles or at other areas where more pronounced crater or rock shadows are unavoidably cast, such dark features become increasingly obscured by the displaced lunar soil dust kicked up by the exhaust at a relatively deterministic rate with altitude.

One or more onboard visible spectrum cameras may be affixed to the lunar lander. The camera may have an array of detectors. Each camera may point roughly parallel (i.e., less than about 30°) to the exhaust vector of an associated thruster, have field of view from about 10° to about 70°, and generally face downward towards the moon. The image capture may have a frame rate greater than about 1 frame per second. The sun angle may be from about 5 degrees to about 80 degrees Above The Horizon (ATH). The sun angle may be taken into account for adequate contrast in imagery taken of the lunar surface. With no shadows behind surface features, or insufficient reflected sunlight, the histogram of such imagery will have inherently less contrast and therefore be of less use for accurate altitude determination. It is estimated that sufficient shadow and reflected light will be available over a majority of the sun angles from about 5 to about 80 degrees above the horizon, and sun angle adjustments in calibration of the imagery data is considered in the altitude algorithm.

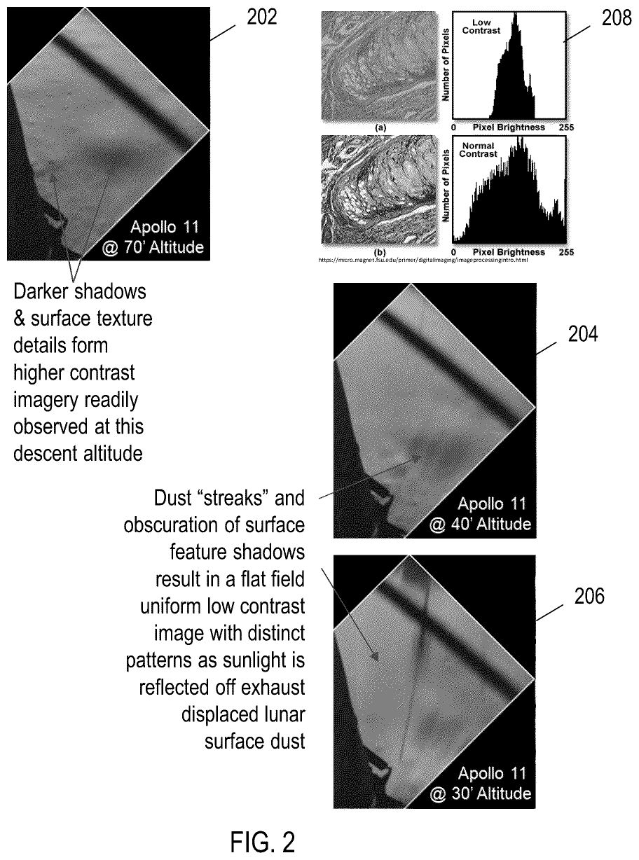

The raw imagery obtained by the cameras may be used to signal the proximity of the lunar lander to the lunar surface based on images that progressively obscure the darker shaded regions in the camera field. This presents flatter and more uniform images, which is referred to as histogram-stretching with closing distance as shown in FIG. 2. FIG. 2 illustrates an example of histogram stretching based on lunar landing, according to some embodiments. With linkage of altitude above the lunar surface to the onset of such raw imaged signatures, this method in conjunction with the use of pattern recognition enables the lunar lander to make appropriate throttle and attitude adjustments for a soft and level terminal phase landing.

This method uses descent camera imagery in the role of a proximity warning device, through visible contrast changes with radial streak patterns present in progressive sequential images of shaded features always encountered upon descent to the lunar surface by a landing vehicle. The use of raw imagery data may be in place of the use of, or in combination with, radar or lasers used for direct rangefinding to the lunar surface to determine altitude, both of which lose effectivity in the dust obscuration region during descent, and neither of which enable avoidance of obstacles (larger craters, rocks).

To reiterate, thrusters used to descend to the moon for any lander kick up a relatively voluminous amount of dust. This dust obscures the ground and renders laser or radar analysis alone untenable because surface features that would normally be visible and used to extrapolate altitude become unavailable, as well as radar reflecting off the dust and lasers being essentially unable to penetrate the dust.

To mitigate this issue, flat fielding or histogram narrowing is used. This technique uses a high contrast surface from shade from craters or rocks that are on the moon to provide information. The contrast of a particular scene is reduced as more dust is kicked up. The contrast reduction may be modeled to end up with a flatter field or a field with an increased amount of structure. In particular, the histogram (the output or the raw output from a focal plane) based on the intensity and/or the amount of light hitting each detector in the camera narrows tremendously because all pixels become the same color; that is, the images become progressively flatter and more uniform and dark features and shadows become increasingly obscured.

While the histogram narrowing is due the amount of dust kicked up (i.e., the amount of obscuration), the focal plane of the camera capturing the images can relate that directly to the altitude above the surface of the moon upon descent because the closer to the moon surface, the more dust the thrusters displace, which in turn fills a larger area of the focal plane with an increased amount of obscuration. The rate at which the histogram stretches may be linked to a known correction for altitude error. By linking the onset and progression of the visual signatures to the altitude of the lunar lander, the system is able to determine the proximity of the lunar lander to the lunar surface. This information may then be used in a closed-loop system to automatically adjust the thruster throttle and attitude to reduce impact and improve leveling during landing.

The system serves as an independent and redundant proximity sensor. In the latter case, the system complements or potentially replaces traditional altitude measurement methods like radar or laser rangefinders. As above, the radar or laser rangefinders can become ineffective due to dust obscuration in the final descent phase (from about 300 meters to about 40 meters.

Accordingly, histogram stretching, in the context used herein, refers to a digital image processing technique used to analyze and enhance the visual characteristics of the lunar descent imagery. In particular, the histogram of an image used herein represents the distribution of pixel intensities (brightness values) in that image. In a typical image, this distribution can vary widely. As the lunar lander descends and kicks up dust, the imagery captured by the onboard camera undergoes significant changes in contrast. Initially, the images have a normal contrast with distinct features and shadows, but the images become progressively flatter and more uniform as dust increasingly obscures the surface features. This results in a narrower range of pixel intensities.

The histogram of dust-affected images becomes more compressed, with pixel values clustered in a narrower range in a phenomenon referred to as “histogram stretching”. The degree of histogram stretching effect is correlated with the altitude of the lander and stored in lookup tables in memory used by the processor. As the lander gets closer to the surface (starting from about 300 feet to about 40 feet dependent on the qualities of the underlying surface), the effect becomes more pronounced. The histogram stretching, along with other pattern recognition techniques, is used to analyze the raw imagery and determine the lander's proximity to the lunar surface. By quantifying the histogram changes, the system can automatically detect when the lunar lander is entering the final descent phase, and control adjustments to engine throttle and attitude based thereon. The information in the lookup tables may be derived from prior landing data of the lunar lander or a lander that is similar to the lunar lander; the histogram narrowing indicated by the lookup tables is directly correlated to altitude.

Returning to FIG. 2, which provides a visual illustration of the image processing described herein. FIG. 2 is divided into panels, each of which depicts a different stage of the lunar descent as seen by cameras of the lunar lander.

The left panel 202 shows an image of the lunar surface at a relatively high altitude, before significant dust obscuration occurs (as shown, at an altitude of about 70 feet from the surface of the moon). The image of the surface is characterized by pronounced shadows and texture details, such as those cast by craters and rocks. These features create a high-contrast image of the scene, with a wide range of pixel brightness values. The corresponding histogram accordingly displays a broad distribution, reflecting the diversity of light and dark regions in the image.

Significant dust obscuration (or dust obscuration above a predetermined threshold) occurs at altitudes ranging from approximately 300 feet to 40 feet above the lunar surface, depending on local regolith properties, engine thrust, and descent profile. The onset of significant dust obscuration is detected when one or more of the above quantitative criteria are met, triggering the system to rely on camera-based proximity estimation for altitude determination and descent control.

As used herein, significant dust obscuration refers to a condition during the terminal descent of a lunar lander in which the exhaust plume from the descent engine displaces lunar regolith dust to an extent that the visibility of surface features in the field of view of the camera is measurably reduced, resulting in a substantial loss of image contrast. This may set at a predetermined altitude from the lunar surface, which in turn may depend on the composition of the underlying lunar surface. Alternatively, significant dust obscuration may be quantitatively defined by one or more of: the standard deviation of pixel intensities within a selected region of interest in the camera image decreases by at least 50% compared to the baseline value established prior to dust displacement; the difference between maximum and minimum pixel intensity values within the selected region of interest falls below a predetermined threshold, such as less than 30% of the initial baseline contrast, distinct lunar surface features (e.g., craters, rocks, shadows) that were previously resolvable in the image become indistinct or undetectable, as determined by a feature detection algorithm or pattern recognition metric, or the majority (e.g., more than 70%) of pixel intensity values within the selected region of interest cluster within a narrow range (e.g., within 20 grayscale levels in an 8-bit image), indicating a flattening of the image histogram.

The middle right panel 204 shows a lower altitude with increased dust obscuration compared to the left panel. This panel depicts the same region of the lunar surface as the lander descends to a lower altitude and the engine exhaust begins to displace lunar dust. As shown in the top image, at an altitude of about 40 feet from the surface of the moon, the dust plume creates streaks and increasingly obscures surface features, resulting in a flatter, more uniform image with lower contrast. Shadows and texture details become muted or disappear entirely as shown in the lower right panel 206 of about 30 feet from the surface of the moon. The corresponding histograms 208 for these images are accordingly narrower than that of the higher 70 foot altitude, with pixel values clustered around a central brightness, indicating the loss of contrast due to dust.

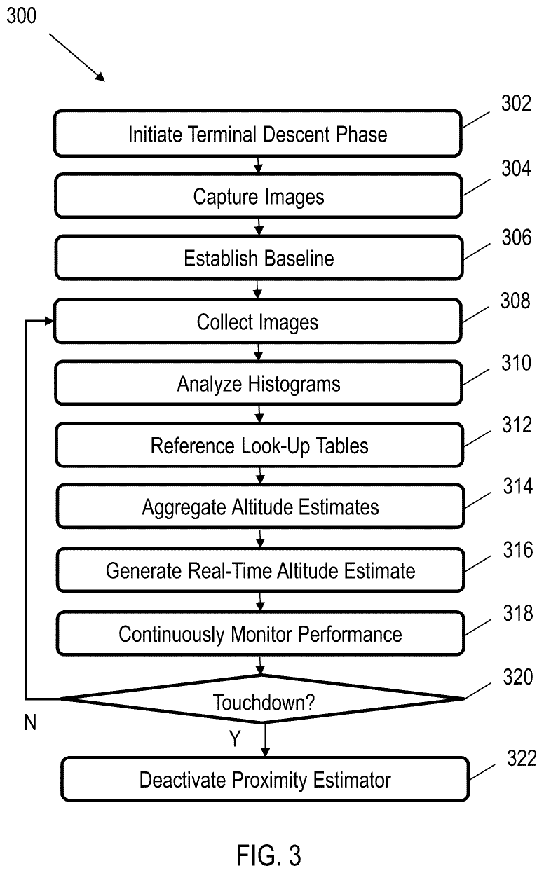

FIG. 3 illustrates a method of histogram stretching for lunar landing, according to some embodiments. In some embodiments, the electronic device(s), network(s), system(s), chip(s) or component(s), or portions or implementations thereof may be configured to perform one or more processes, techniques, or methods as described herein, or portions thereof. Only some of the operations are shown in the method 300 of FIG. 3; other operations may be present but are not shown.

At operation 302, the system initiates the terminal descent phase. This may include activating (use of) the onboard cameras and image processing module as the lunar lander approaches a predetermined altitude threshold (e.g., 300 feet above the lunar surface). The system may adjust camera parameters, e.g. orientation, field of view, with the field of view directed toward the landing site and aligned to capture relevant surface features. The cameras may have a variable field of view and/or adjustable orientation, which can be adjusted by the processor to maximize capture of contrast features as the lunar lander descends. The processor may select among the cameras to use fewer than all of the available cameras based on the quality of the captured images and/or the persistence of contrast features while reducing the amount of data to process. The processor may also identify and track specific types of lunar surface features and assign feature-specific weights during altitude estimation.

In some embodiments, the camera field of view may be known and a constant for historical imagery purposes. In this case, the camera field of view algorithm may intentionally crop to the field of view (if larger than the constant), or a portion of the field of view (if smaller than the constant) to match the histogram detail. The landing histogram database can grow with additional landing imagery (future or historical) and be updated and refined for increased accuracy and field of view/resolution fidelity. For lander systems, the boresight vector for the camera can be designated as the boresight vector relates to the coordinates of the descent vehicle. The distance from image center translates to the angle from the image center, which in turn translates into the field of view in three-dimensional space, depending upon attitude of the lander.

At operation 304, the camera captures real-time images of the lunar surface. The image processing software analyzes the images to identify regions of high contrast, such as craters, rocks, and associated shadows. The system computes the histogram of pixel intensities for the entire image and for multiple candidate regions, selecting regions of interest (ROIs) that exhibit the greatest contrast. Thus, the cameras on the lunar lander capture images of the lunar surface at the outset of terminal descent before significant dust obscuration; the processor then computes the histogram of pixel intensities across each image or within sub-regions of the image. A wide histogram (broad distribution of pixel values) indicates the presence of both bright and dark areas, i.e., high contrast due to features and shadows. The processor may segment the image into multiple candidate regions and select one or more regions with the greatest contrast (i.e., regions where the difference between maximum and minimum pixel values, or the standard deviation, is highest). This ensures that the selected ROI contains meaningful surface features rather than featureless terrain.

Camera detectors may be sampled to identify areas of higher contrast within the field of view, and if persistent over several frames of camera data, may be tagged and monitored in the algorithm for changes in size, position, and contrast. These sub-areas may be identified progressively upon descent as the sub-areas enter or leave the field of view, or for histogram purposes as the sub-areas change in contrast. Regolith composition variation is bounded via historical data analysis, and future landing imagery as the variation can serve to augment the algorithm database. Ground slope of modest degree (about 5 to about 10 degrees) should not affect the altitude imagery, but may be of concern for the lander depending on the lander design. Typically, a general landing site area is identified prior to landing and deliberately selected to avoid high ground slope conditions (i.e. the sides of hills, rises, or similar features).

In some embodiments, a minimum number of bins is an estimate until the historical imagery is analyzed and reduced, but is likely in the range of 10 to 20 bins, with a higher number being preferred. Camera resolution may be related to the minimum size artifacts on the lunar surface to be imaged for contrast and field of view. While higher resolution may be preferred, a sub-field of the field of view could be imaged for histogram purposes with even a lower resolution camera. Historical imagery and histogram data can be used to bound a minimum resolution camera field. Camera sensitivity (bit depth) to the extent that shadow and bright surface signatures can be determined, is typically not problematic in imaging systems.

At operation 306, the system establishes a baseline by storing the initial histogram characteristics (e.g., width, mean, standard deviation) for each selected ROI. This baseline represents the unobscured or minimally obscured state of the lunar surface features and serves as a reference for subsequent analysis as the descent continues.

At operation 308, as the lander descends and the thrusters begin to displace lunar dust, the camera continues to capture sequential images. The image processing module dynamically tracks the selected ROIs, adjusting the ROI position and size to compensate for changes in the field of view or movement of features within the image to continue tracking the most contrast-rich areas. The processor may detect and compensate for camera contamination or loss of contrast due to dust accumulation on the camera lens.

Sub-field artifacts (brightness peaks and shadows) can be identified locally within the field of view early in the descent. These artifacts may then be tracked for changes in size (within the field of view) and increasing angle to gauge lander height above the lunar surface due to changes in parallax. In the later stages of descent, when such artifacts may comprise a larger sub-field solid angle within the field of view (if the artifacts have not moved out of the field of view), the relative size relate directly to altitude via an r-squared distance relationship. The high-contrast features are markers that change the histogram contrast, with greater uniformity and radial structure being directly related to proximity of the lunar surface. Change detection algorithms may be used to recognize motion between frames. In versions that run in real-time, these changes give angular changes per frame, which in turn yields the position and orientation of the camera.

At operation 310, the system analyzes the histograms of the tracked ROIs in each new image, monitoring for changes in histogram characteristics. Specifically, the system determines the narrowing or stretching of the histogram that indicates increasing dust obscuration and loss of contrast. The system compares the current histogram data to the established baseline for each ROI. The amount of histogram change can vary depending on the type, size, and location of the features (e.g., large craters vs. small rocks, deep shadows vs. shallow ones). The processor can monitor histogram changes for multiple ROIs, each corresponding to different features or areas within the field of view of the camera. By tracking how the histogram for each ROI narrows over time, the system can observe the differential effects of dust on various features.

At operation 312, the system references pre-calibrated lookup tables or models that relate the degree of histogram narrowing for each type of feature or ROI to the altitude of the lunar lander above the lunar surface. The tables may be derived from historical landing data or simulation and account for different dust behaviors and regolith properties. The lookup tables relate the histogram characteristics of different types of features to altitude, under various dust conditions. The tables account for the fact that some features may become obscured at higher altitudes than others, depending on the contrast and the local regolith properties. Given that the historical lunar landing imagery has known altitude callouts, the statistical and structural (e.g. radial spokes from thrust center) histogram characteristics from the imagery can be correlated to altitude above the lunar surface. The calibration of the historical imagery may be compared from landing to landing to account for variations seen in differing landing sites (potential variations in lunar surface material amounts and characteristics) and descent profiles (i.e. speed, attitude, sun angle).

At operation 314, the system aggregates the altitude estimates from the ROIs, applying weights based on the reliability and persistence of the contrast of each feature. If the histogram behavior of a particular ROI deviates from expected patterns, the system adaptively reduces its influence and relies more heavily on other features or the aggregate histogram for the entire image. For example, if a large shadowed crater remains visible longer than smaller rocks, the histogram data of the ROI containing the large shadowed crater may be given more influence in the altitude estimation. If the histogram stretching for a particular feature deviates from expected patterns (e.g., due to unusual dust behavior or lighting), the processor can adapt by relying more on other features or by referencing the aggregate histogram for the entire image.

At operation 316, the system generates a real-time estimate of the proximity of the lunar lander to the lunar surface based on the combined histogram analysis. The altitude estimate is provided to the control system of the lunar lander. The control system uses the altitude estimate to adjust the descent rate and attitude by modulating the thrusters for a soft and level landing.

At operation 318, the system continuously monitors the performance of both the camera-based proximity estimation and traditional sensors (e.g., radar, lidar, laser rangefinders). The processor may provide a confidence metric or error estimate associated with each proximity determination by comparison to data from the other sensors.

If the system determines that the traditional sensors have become unreliable due to dust obscuration, the system automatically prioritizes the camera-based method as the primary source of altitude data. The determination of unreliability may be determined by the processor by one or more measurements, which include for a particular sensor: the sensor fails to return a valid measurement for a predetermined number of consecutive cycles (e.g., no valid range data for 3 or more sequential readings), the standard deviation or variance of the sensor's range measurements within a short time window (e.g., 1-2 seconds) exceeds a predetermined threshold, such as a 100% increase over baseline variance measured prior to dust onset, an altitude determined using the sensor output deviates from the last known reading by more than a set threshold (e.g., a sudden jump of 20% or more in measured altitude within one second), the amplitude or intensity of a return signal of the sensor falls below a minimum operational threshold, indicating excessive scattering or absorption by dust (e.g., signal-to-noise ratio drops below 2:1), or the sensor falsely indicates surface contact or zero altitude while the lander is still above the lunar surface, as determined by cross-checking with inertial measurement units, other sensor, and/or image-based data. When one or more of these criteria are met, the system determines that the radar, lidar, or laser rangefinder data is unreliable, e.g., to be used alone for altitude data and thrust control, due to dust obscuration and prioritizes alternative altitude estimation methods, such as camera-based proximity analysis. In some embodiments, upon such a determination, the imaging based thrust control for lunar landing may be used alone or in combination with the other sensor (e.g., radar, lidar, and/or laser rangefinder) data based thrust control techniques.

At operation 320, the process repeats in a closed-loop fashion, with the camera capturing new images, the system updating histogram analyses, and the control system making real-time adjustments until touchdown is detected by the landing system. In some cases, the confidence of the proximity estimation may be measured, and the processor may issue a warning or alert if the proximity estimation confidence falls below a predetermined threshold. The proximity estimation confidence refers to a quantitative or qualitative assessment of the reliability or accuracy of the altitude estimate generated by the image-based system. This confidence can be measured using one or more approaches. The processor may calculate the variance or standard deviation of altitude estimates across multiple sequential images or ROIs in which low variance indicates high confidence while high variance suggests uncertainty. The processor may determine that the confidence is higher when multiple high-contrast features remain detectable and their histogram changes are consistent with expected patterns; if features become indistinct or the histogram data diverges from the lookup table, the confidence may decrease to below a predetermined threshold. The processor may compare image-based altitude estimates with data from other sensors (e.g., IMUs, radar, lidar), in which agreement between systems increases confidence; significant discrepancies reduce the confidence. The processor may use metrics such as signal-to-noise ratio, histogram clustering, or the number of valid ROIs contributing to the estimate to determine the confidence. The processor may generate an error bound or confidence interval for each proximity estimate, based on model fit, feature detection reliability, and environmental factors.

When the proximity estimation confidence falls below a predetermined threshold, the system can issue various types of warnings or alerts. These warnings or alerts can include visual and audible alerts to the lander crew or user in control, flagging data by tagging the proximity estimate data with a low confidence flag for downstream systems or post-mission analysis, and/or automated system notification in which a signal is sent to the flight computer or control system to trigger predefined contingency protocols. The effects of the warning or alert include system prioritization, in which the control system may switch to alternative altitude measurement methods (e.g., revert to radar, lidar, or IMU data) if available and reliable. The lander may also reduce descent rate, increase safety margins, or enter a pre-programmed safe mode to minimize risk during landing. For crewed or remotely monitored missions, operators may be prompted to take manual control or initiate backup procedures. The event may be logged for post-mission review, diagnostics, or future algorithm improvement. In extreme cases, the system may trigger an abort or landing hold if confidence is insufficient for a safe touchdown.

In some embodiments, when traditional systems (radar, laser) start to diverge (i.e., provide different readings outside of their expected and tested accuracy on the ground), the camera descent algorithm can be invoked and/or polled for altitude consistency. Laser signal typically is scatter, meaning a lower intensity return and/or a non-changing altitude measurement when altitude change is expected. Radar return imagery can become noisy or lose resolution to features on the ground, particularly if the return is non-uniform. In either case, the camera system can be used to passively and progressively integrate with higher altitude instrument measurements and trended to eventually supplant them in the terminal descent phase. Criteria to trigger the cutover to camera imagery could occur at any time as determined by the operator, in the event of any falloff or failure of other altitude termination systems, when the thresholds of traditional systems have not been met or have been exceeded, or if the operator's analysis of data dictates the switch to the camera-based system. As a preliminary estimate, the highest efficacy for the camera system may be from about 300 to about 40 feet in lunar altitude for histogram algorithm purposes, but can be used at higher altitudes for contrasting images in the field of view via ground feature angular subtense (size) and parallax angle techniques.

Upon successful landing, the system deactivates the proximity estimation module at operation 322. The historical image and histogram data determined during the controlled descent may be stored and used for post-landing analysis and mission debriefing, as well as updating lookup tables in the lunar lander and other lunar landers.

Thus, in the method 300 raw camera images are used for real-time, closed-loop control of descent and attitude, based on dust-induced contrast changes. The system identifies omnipresent lunar surface features (craters, rocks) to ensure initial contrast, and subsequently uses the deterministic obscuration of the features by dust, as indicated by histogram stretching, as a reliable proximity indicator.

The image-based proximity technique described may operate as a backup, redundant, or primary altitude measurement system. Primary altitude measurement systems refer to the main onboard instruments or sensor suites of a lunar lander that are designated to provide real-time measurements of the lander's altitude above the lunar surface during descent and landing operations. These systems typically include, but are not limited to, radar altimeters, lidar sensors, and laser rangefinders. Primary altitude measurement systems are relied upon for accurate and continuous altitude data under nominal conditions. They are distinguished from backup or redundant altitude measurement systems, such as camera-based proximity estimation, which may be activated in response to the primary altitude measurement systems becoming unreliable due to environmental factors like dust obscuration. The image-based proximity technique can provide continuous altitude updates or may be operative only during the terminal descent phase; that is, the system may be operative only once the sensors indicate that a predetermined altitude (e.g., 300 feet) has been reached above the lunar surface. In some cases, the altitude may be dependent on the known characteristics of the local lunar surface (i.e., the location where the lunar lander is landing).

### EXAMPLES

Example 1 is an apparatus for controlling descent of a lunar lander, comprising: a camera configured to capture sequential images of a landing site on a lunar surface during terminal descent by the lunar lander; a memory configured to store a lookup table; and a processor coupled to the camera and configured to: identify, within the images, regions of interest that exhibit high contrast features; compute histograms of pixel intensities for the regions of interest; establish a baseline histogram for each region of interest prior to dust obscuration above a predetermined threshold; monitor changes in the histograms as the lunar lander descends and dust is displaced by engine exhaust of the lunar lander; correlate, using the lookup table, histogram changes to altitude above the lunar surface; generate, based on a correlation of the histogram changes, a real-time proximity estimate of the lunar lander to the lunar surface; and adjust at least one of descent rate or attitude of the lunar lander in response to the proximity estimate through generation of control signals to be sent to a propulsion system and thrusters of the lunar lander.

In Example 2, the subject matter of Example 1 includes, wherein the processor is further configured to dynamically track and adjust the regions of interest to compensate for movement and changes in a field of view of the camera during the terminal descent.

In Example 3, the subject matter of Examples 1-2 includes, wherein the camera is oriented to capture images in a direction substantially parallel to an exhaust vector of at least one of the thrusters.

In Example 4, the subject matter of Examples 1-3 includes, wherein the processor is configured to aggregate proximity estimates from multiple regions of interest and apply weighting based on persistence and reliability of contrast features in each region of interest.

In Example 5, the subject matter of Examples 1-4 includes, wherein the processor is configured to: determine whether radar, lidar, and laser rangefinder data from sensors has become unreliable due to dust obscuration based on at least one of: valid radar, lidar, and laser rangefinder data not being returned for a predetermined number of consecutive cycles, a standard deviation of range measurements within a predetermined time window exceeds a predetermined threshold, an altitude determined using the radar, lidar, and laser rangefinder data deviates from a last known altitude by more than a predetermined threshold, an amplitude or intensity of a return signal falls below a minimum operational threshold, or the sensors indicate surface contact while the lunar lander is still above the lunar surface; and automatically prioritize proximity estimation of the lunar lander to the lunar surface using the images over use of the radar, lidar, and laser rangefinder data in response to a determination that the radar, lidar, and laser rangefinder data has become unreliable.

In Example 6, the subject matter of Examples 1-5 includes, wherein the lookup table is derived from at least one of historical lunar landing data and simulated descent imagery and accounts for variations in lunar regolith composition and dust behavior.

In Example 7, the subject matter of Examples 1-6 includes, wherein the processor is configured to provide continuous altitude updates throughout the terminal descent and to deactivate proximity estimation upon detection of surface touchdown.

In Example 8, the subject matter of Examples 1-7 includes, wherein the processor is configured to select the regions of interest based on statistical measures of contrast, including at least one of maximum-minimum pixel value difference and standard deviation of pixel intensities.

In Example 9, the subject matter of Examples 1-8 includes, wherein the processor is configured to use proximity estimation of the lunar lander to the lunar surface using the images as a redundant or backup proximity technique in addition to primary altitude measurement systems.

In Example 10, the subject matter of Examples 1-9 includes, wherein the camera has at least one of a variable field of view and adjustable orientation to maximize capture of contrast features as the lunar lander descends.

In Example 11, the subject matter of Examples 1-10 includes, wherein the processor is configured to select among multiple cameras to use fewer than all of the cameras based on at least one of quality of the images and persistence of contrast features.

In Example 12, the subject matter of Examples 1-11 includes, wherein the processor is configured to identify and track specific types of lunar surface features and to assign feature-specific weights during altitude estimation.

In Example 13, the subject matter of Examples 1-12 includes, wherein the processor is configured determine proximity estimation confidence and generate a warning or alert in response to the proximity estimation confidence falling below a predetermined threshold.

Example 14 is a non-transitory computer-readable storage medium that stores instructions for execution by one or more processors of a lunar lander to control descent of the lunar lander, the one or more processors, when the instructions are executed, to: capture, using a camera, sequential images of a landing site on a lunar surface during terminal descent by the lunar lander; identify, within the images, regions of interest that exhibit high contrast features; compute histograms of pixel intensities for the regions of interest; establish a baseline histogram for each region of interest prior to dust obscuration above a predetermined threshold; monitor changes in the histograms as the lunar lander descends and dust is displaced by engine exhaust of the lunar lander; correlate, using a lookup table, histogram changes to altitude above the lunar surface; generate, based on a correlation of the histogram changes, a real-time proximity estimate of proximity of the lunar lander to the lunar surface; and adjust at least one of descent rate or attitude of the lunar lander in response to the proximity estimate through generation of control signals to be sent to a propulsion system and thrusters of the lunar lander.

In Example 15, the subject matter of Example 14 includes, wherein the one or more processors are configured to, when the instructions are executed, dynamically track and adjust the regions of interest to compensate for movement and changes in a field of view of the camera during the terminal descent.

In Example 16, the subject matter of Examples 14-15 includes, wherein the one or more processors are configured to, when the instructions are executed, aggregate proximity estimates from multiple regions of interest and apply weighting based on persistence and reliability of contrast features in each region of interest.

Example 17 is a control system for a lunar lander, the control system comprising: a processor configured to: receive images, obtained by a camera of the lunar lander, of a landing location on a surface of a moon and lunar dust particles kicked up from the surface by exhaust of thrusters of the lunar lander, process the images to determine proximity of the lunar lander to the surface, and based on the proximity determined using the images, adjust a descent rate and attitude of the lunar lander to the surface of a moon based on images; and a memory configured to store the descent rate and attitude of the lunar lander.

In Example 18, the subject matter of Example 17 includes, wherein the images are parallel to an exhaust vector of at least one of the thrusters in a direction facing the moon.

In Example 19, the subject matter of Example 18 includes, degrees Above The Horizon (ATH).

In Example 20, the subject matter of Examples 17-19 includes, wherein the processor is configured to determine differences in histograms of pixel brightnesses between successive images of the surface during descent to the surface and use a relationship, stored in the memory, between the histograms to determine the proximity of the lunar lander to the surface.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” Although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow. In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for controlling descent of a lunar lander, comprising:
a camera configured to capture sequential images of a landing site on a lunar surface during terminal descent by the lunar lander;
a memory configured to store a lookup table; and
a processor coupled to the camera and configured to:
identify, within the images, regions of interest that exhibit high contrast features;
compute histograms of pixel intensities for the regions of interest;
establish a baseline histogram for each region of interest prior to dust obscuration above a predetermined threshold;
monitor changes in the histograms as the lunar lander descends and dust is displaced by engine exhaust of the lunar lander;
correlate, using the lookup table, histogram changes to altitude above the lunar surface;
generate, based on a correlation of the histogram changes, a real-time proximity estimate of the lunar lander to the lunar surface; and
adjust at least one of descent rate or attitude of the lunar lander in response to the proximity estimate through generation of control signals to be sent to a propulsion system and thrusters of the lunar lander.

2. The apparatus of claim 1, wherein the processor is further configured to dynamically track and adjust the regions of interest to compensate for movement and changes in a field of view of the camera during the terminal descent.

3. The apparatus of claim 1, wherein the camera is oriented to capture images in a direction substantially parallel to an exhaust vector of at least one of the thrusters.

4. The apparatus of claim 1, wherein the processor is configured to aggregate proximity estimates from multiple regions of interest and apply weighting based on persistence and reliability of contrast features in each region of interest.

5. The apparatus of claim 1, wherein the processor is configured to:
determine whether radar, lidar, and laser rangefinder data from sensors has become unreliable due to dust obscuration based on at least one of: valid radar, lidar, and laser rangefinder data not being returned for a predetermined number of consecutive cycles, a standard deviation of range measurements within a predetermined time window exceeds a predetermined threshold, an altitude determined using the radar, lidar, and laser rangefinder data deviates from a last known altitude by more than a predetermined threshold, an amplitude or intensity of a return signal falls below a minimum operational threshold, or the sensors indicate surface contact while the lunar lander is still above the lunar surface; and
automatically prioritize proximity estimation of the lunar lander to the lunar surface using the images over use of the radar, lidar, and laser rangefinder data in response to a determination that the radar, lidar, and laser rangefinder data has become unreliable.

6. The apparatus of claim 1, wherein the lookup table is derived from at least one of historical lunar landing data and simulated descent imagery and accounts for variations in lunar regolith composition and dust behavior.

7. The apparatus of claim 1, wherein the processor is configured to provide continuous altitude updates throughout the terminal descent and to deactivate proximity estimation upon detection of surface touchdown.

8. The apparatus of claim 1, wherein the processor is configured to select the regions of interest based on statistical measures of contrast, including at least one of maximum-minimum pixel value difference and standard deviation of pixel intensities.

9. The apparatus of claim 1, wherein the processor is configured to use proximity estimation of the lunar lander to the lunar surface using the images as a redundant or backup proximity technique in addition to primary altitude measurement systems.

10. The apparatus of claim 1, wherein the camera has at least one of a variable field of view and adjustable orientation to maximize capture of contrast features as the lunar lander descends.

11. The apparatus of claim 1, wherein the processor is configured to select among multiple cameras to use fewer than all of the cameras based on at least one of quality of the images and persistence of contrast features.

12. The apparatus of claim 1, wherein the processor is configured to identify and track specific types of lunar surface features and to assign feature-specific weights during altitude estimation.

13. The apparatus of claim 1, wherein the processor is configured determine proximity estimation confidence and generate a warning or alert in response to the proximity estimation confidence falling below a predetermined threshold.

14. A non-transitory computer-readable storage medium that stores instructions for execution by one or more processors of a lunar lander to control descent of the lunar lander, the one or more processors, when the instructions are executed, to:
capture, using a camera, sequential images of a landing site on a lunar surface during terminal descent by the lunar lander;
identify, within the images, regions of interest that exhibit high contrast features;
compute histograms of pixel intensities for the regions of interest;
establish a baseline histogram for each region of interest prior to dust obscuration above a predetermined threshold;
monitor changes in the histograms as the lunar lander descends and dust is displaced by engine exhaust of the lunar lander;
correlate, using a lookup table, histogram changes to altitude above the lunar surface;
generate, based on a correlation of the histogram changes, a real-time proximity estimate of proximity of the lunar lander to the lunar surface; and
adjust at least one of descent rate or attitude of the lunar lander in response to the proximity estimate through generation of control signals to be sent to a propulsion system and thrusters of the lunar lander.

15. The non-transitory computer-readable storage medium of claim 14, wherein the one or more processors are configured to, when the instructions are executed, dynamically track and adjust the regions of interest to compensate for movement and changes in a field of view of the camera during the terminal descent.

16. The non-transitory computer-readable storage medium of claim 14, wherein the one or more processors are configured to, when the instructions are executed, aggregate proximity estimates from multiple regions of interest and apply weighting based on persistence and reliability of contrast features in each region of interest.

17. A control system for a lunar lander, the control system comprising:
a processor configured to:
receive images, obtained by a camera of the lunar lander, of a landing location on a surface of a moon and lunar dust particles kicked up from the surface by exhaust of thrusters of the lunar lander,
process the images to determine proximity of the lunar lander to the surface, and
based on the proximity determined using the images, adjust a descent rate and attitude of the lunar lander to the surface of a moon based on images; and
a memory configured to store the descent rate and attitude of the lunar lander.

18. The control system of claim 17, wherein the images are parallel to an exhaust vector of at least one of the thrusters in a direction facing the moon.

19. The control system of claim 18, wherein the camera is configured to point less than about 30 degrees from an exhaust vector of at least one of the thrusters, the camera having a field-of-view of about 10° to about 70° and an image capture rate of greater than about 1 frame per second at a sun-angle from about 5 to about 80 degrees Above The Horizon (ATH).

20. The control system of claim 17, wherein the processor is configured to determine differences in histograms of pixel brightnesses between successive images of the surface during descent to the surface and use a relationship, stored in the memory, between the histograms to determine the proximity of the lunar lander to the surface.
